(19) United States
(12) Patent Application Publication
(10) Pub. No.: US 2008/0215420 A1
(43) Pub. Date: Sep. 4, 2008

(54) METHOD AND SYSTEM FOR REWARDING ELECTRONIC AUTHORS

(76) Inventor: Steve Angelica, West Hollywood, CA (US)

Correspondence Address: Steve Angelica, 954 Palm Ave., #103, West Hollywood, CA, 90069, US

(21) Appl. No.: 11/681,565

(22) Filed: Mar. 2, 2007

(51) Int. Cl. G06Q 99/00

(52) U.S. Cl. 705/11

(57) ABSTRACT

A method and system are disclosed for incorporating affirmation functions into the electronic interfaces that present media creations submitted by electronic authors. The media creations are ranked in overall prominence within the electronic interface based on affirmations of those who receive the media creation. These affirmations can be in the form of votes of approval, monetary contributions of support, or purchases of copies of the media creations. Where the affirmations are monetary these are then shared with the electronic authors as a reward. In the case of streaming media creations, the authors are given notice of their scheduled broadcast appearances to enable them to self promote to their own established audience bases, and the interface includes the capability of accessing the information associated with previous tracks played. The affirmations can also be weighted according to the number of receivers of the media creations.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office Patent file or records, but otherwise reserves all copyrights whatsoever.

### BACKGROUND

The growth of electronic communication over the internet has spawned new forms of communication formats which have rapidly become ubiquitous in world culture, like email and web sites. One of the fastest growing aspects of this new culture is the so-called web blog or just simply “blog”. These are web sites that function as personal electronic bulletin boards, where either one person can post their own electronic musings, or where multiple authors can be authorized to post their pieces to the same blog site. Blog service providers have appeared to allow the non-technical person to adopt an off the shelf functional blog, the look of which they can further customize if they are so inclined.

For last three years the number of new blogs has doubled about every six months, with the total started estimated now at over 50 million. The number seriously active is likely much less, though still very substantial. But it is not just blogs, as people think of them, that are experiencing such growth. Also included in this phenomenon should be sites like MySpace.com, which allow a person to quickly build their own personally customized web site around a pre-configured template, providing parallel functions for which other people might use a blog. For this reason we will speak of blogs in the expansive sense as any electronic interface where an electronic author might get their work posted and thereby experienced.

From this perspective, though perhaps not immediately recognizable as such, web sites like YouTube.com which allow for posting of video content are also a form of blog, where instead of written comments people may post their own video clips as the primary contribution. In their present embodiment, the YouTube system is structured as a searchable database. Though advertised with the slogan “broadcast yourself”, there is no discrete YouTube broadcast akin to a TV signal. Neither is there currently a site with any programmed radio type broadcast of audio content which can be contributed to by the public on a posting basis. In the audio realm Last.fm is structured in fundamentally the same way as YouTube.

Electronic bulletin boards in general usage in fact predate the broader availability of ready internet connections. In the early days one would connect to a server by individual dial-up modem connection, and could post and download text messages or files. With the advent of the graphic web browser it became more convenient to view and exchange pictures and other media content via this medium. With the additional rise of internet service providers to enable individually connected users to access a globally connected electronic backbone, it became possible for a posting on a web site to be available instantly to the world. In practical point of fact, the primary difference between blogs and other sites that publish news articles, commentary and the like, such as the major news network sites, is that posting rights are more restrictive and selective for the latter, though the more prominent blogs may now require pre-posting authorization. The largest and most successful blogs are not just soap boxes for single posters, they get submissions from a broad spectrum of diverse voices.

Currently blogs have commonly associated with them a number of distinctive functions associated with individual posts. One may copy a shortcut link for a particular post to be saved so that one can navigate back to that post at a later time. One may click on a function to send a link to that particular post to friends, inputting their email addresses for that purpose. The purpose of this feature as used has been to build traffic for the source site, but not for the particular purpose of soliciting feedback, though this may be taken as a form of indirect affirmation. Various sites track how many visitors are arriving at particular pages and may make this information available in the form of an index page dedicated for this purpose. A blog post may include graphics, audio or even playable video clips as noted above, but simple visitors can also add on their own text messages, with the popularity of the chat aspect of this function fueling the growth of blog traffic.

Various sites also have functions where a visitor can register affirmations of approval in some direct way, by voting for or rating on some scale their favorite articles or videos, etc. In such cases the results of compiling these affirmations are also confined to index ranking pages available as a segregated function. If one is inclined to view the derived rankings they may be searched. But what is not seen is any meaningful impact on the decisions to feature or not feature particular postings within the web site itself. For example, on YouTube.com the “featured” videos on their main home page are currently selected by an “editor”, whereas finding links to the pages showing “Top Rated” or “Top Favorites” requires some hunting around. Likewise with MSNBC.com which has a “Most Popular” page in their menu selections. But none of the entries there are necessarily included on their main front page featured in any way. This is all very nice but it doesn't do much for the creators of these posts themselves. There are also sites like Netscape.com that take votes and rank external sites, sometimes framing their content in a surrounding web page frame set. In no such case are the results of such votes transmitted back to the originating site.

While some web sites, including blogs, incorporate features where visitors can contribute money to support those sites, there has really been no specific provision to compensate individual posting contributors for their work based on direct visitor feedback. A web site could certainly on its own initiative pay authors for contributions just the way conventional magazines have always paid their contributors. But this is a matter between the site and the author, and the visitors of the site do not determine what a particular author should receive.

Indeed those who are posting to blogs now do so almost exclusively without any expectation of compensation whatsoever, outside of the pride of being published on the internet. And yet those blogging contributors are providers of the primary content which is drawing visitors to the blog in the first place. The blog owner can greatly benefit by exploiting the traffic of those visitors to make agreements with advertisers wanting exposure on their blog site, but there is no mechanism in place to relate the value to a visitor of particular posting and the compensation that a author might duly receive as an expression of that value. A site may choose to share advertising revenue with its posters, perhaps based on total viewer traffic, but the degree of such compensation is not dependent on any affirmative act that a visitor is aware of taking.

Based on the foregoing it is respectfully submitted that there is need for a method and system of enabling visitors to affirm and on that basis reward electronic contributors for pieces those visitors especially appreciate, for their wit, their wisdom, their activism, or their entertainment value. This reward can be either simply increased prominence for their work, or also tangible monetary compensation. The interactive potential of internet transactions makes this something that could be done in a facile way with direct affirmation links incorporated into the electronic interface itself, for anyone with the vision to implement it. This would not only benefit the authors directly, it would also benefit the blogs or other web sites themselves by giving them the ability to provide extra incentive for the best and most engaging authors to post to them, and to best monitor and track the appeal of those postings.

This disclosure teaches how to construct such a rewards model, both as a feedback driver for the programming decisions of the blog itself and as a source of income. Employing such a system a web site or provider of blog sites may have a compelling competitive edge over other sites which do not, both in attracting authors to the blogs, and in attracting blogs to the web site service providers themselves.

### SUMMARY

The present invention is directed to enabling new interactive models of rewarding electronic authors for the contribution of their media creations as content for web sites and other electronic transmission interfaces. A method and system are disclosed where affirmation functions are incorporated directly into the original source publishing presentation interface where the media creation is to be posted. These affirmation options can include the ability to vote approval on or to rate an author's media creations by those who perceive them. These votes and ratings are then used to rank various postings among each other, to give greater prominence to those receiving the most direct approval. As a financial reward, contributions can be solicited to support these authors based on the perceived value of their work, and these funds can be shared with the authors to support them in that work. Furthermore, where the media creation is such that sale of a copy might be desired or appropriate this can add to the income stream to be shared with the respective authors, and this can be an immediate option upon initial perception.

In the case of streaming media content, increased prominence can take the form of the number of plays, their times, and where the broadcast interface provides for a selection of multiple channels even the transmission channels where they occur. With multiple channels the net effect can be to create a “farm club” system where media creations which are performing well can be promoted to the more primary channels. In this system the media authors can be notified in advance as to not only where, but also when their media creations will play, so that they may do their own recruiting of visitors to vote on and boost their rankings in the system, serving to reward those who best recruit new receivers.

### BRIEF DESCRIPTION OF THE DRAWINGS

FIG. 1 is a screen shot of a sample embodiment of the present invention applied as a multiple channel radio receiver, showing direct affirmation links to vote approval and also to purchase the current track playing in support of the electronic author and the hosting network itself, together with relevant descriptive information, artwork and other links.

FIG. 2 is a screen shot of a sample embodiment of the present invention applied as a blog page post, showing direct affirmation links both to make contributions and to cast votes of approval, together with a listing of top posts according to those affirmations.

### DETAILED DESCRIPTION

Some preliminary definitions will facilitate an understanding of the various novel aspects of the instant invention. A “media creation” is a work comprising words, sounds, visual images or any other perceptible expressive things, in any combination, which can be represented in an electronic form, either stored as a finished product or as a live performance. An “electronic author” is one who brings together in a presentable form a media creation. An “electronic interface object” is the presentation vehicle for a media creation. In the case of a simple internet web page this would be the source page together with associated text, graphics and links. Where there is a media player involved with its own controls, as in an audio or video player, and not associated with a particular web page, the media player is itself the electronic interface object. Or the web page can include in the media player as an embedded page object. An electronic interface object is “programmed” by the arrangement of media creations within it. An “electronic publishing entity” is an administrative organization that arranges media creations submitted by electronic authors within the electronic media object, by either place, time or both.

A “receiver” is a person who experiences a media creation through an electronic interface object. Where the electronic interface object is a internet web page, a “visitor” who accesses that web page means the same thing as a receiver. An “affirmation” is an act taken by the receiver directly back through the electronic interface object, as a vote of approval of, or to financially support at least in some part the electronic author of, the media creation so experienced. A “vote of approval” may take the form of either a simple vote or a rating on a graduated scale. Financial support may be a straight contribution or the purchase of a copy of the media creation. Where the editorial decisions as to what media creations to feature in the electronic interface object are being made based substantially on these affirmations, it would be said to be impacting the “overall prominence” of the media creation within the media interface object. “Rewarding” means to give substantial benefit, which can be by giving the benefit of increased prominence, or by sharing some portion of income with the electronic author of the media creation.

A “streaming media broadcast” is an audio or video presentation where multiple receivers can experience the same presentation from the same source signal at the same time, not accounting for differences in transmission or relay times from the original source. Where an electronic interface object provides for a selection of different available signals each such available discrete signal is a “channel”. For a streaming presentation the “broadcast location” is the broadcast time and channel placement of the media creation, otherwise it would be information sufficient to locate the media creation within the electronic interface object. A broadcast location that averages more receivers would be one with increased prominence, which for a web page could also be measured by the period during which a media creation is available and its positional placement on that page.

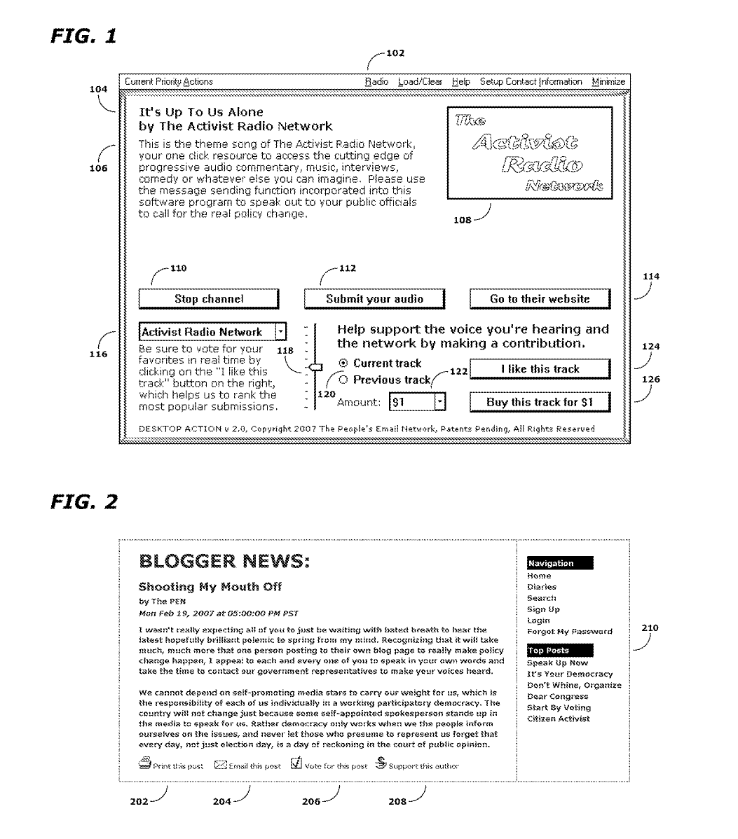

As a first example embodiment of the instant invention we will describe a radio type electronic interface object with multiple channel capability, made available as a computer software download. In this particular embodiment the radio interface is a menu selection, 102 of FIG. 1, added to the interactive electronic desktop action interface previously described in this inventor's patent application Ser. No. 11/318,657, filed Dec. 27, 2005 (and its subsequent International Patent Application PCT/US06/62521, filed Dec. 21, 2006), currently pending. However, the same radio interface could be alternatively rendered by one skilled in the art as a freestanding web object with the same self-contained capabilities, including all affirmation links, and not necessarily connected to a required additional software download.

Given that this particular embodiment is a streaming media broadcast, we can coordinate, together with the current track playing, its title and its electronic author, 104 of FIG. 1, an elaborated description, 106, and an optional related artwork graphic, 108. Many streaming media formats already provide comment tag fields in their digital headers which makes this feasible. We have provided a start/stop button, 110, shown here in the state where the broadcast is being played. Clicking on this button would stop the audio and change the text of the button to “Play Channel”, which would then restart the reception upon a subsequent click. 116 of FIG. 1 is a channel selector implemented as pull down menu. There is also a volume control, 118, to adjust the sound level while playing. A receiver who wants to find out more about an electronic author can click on the button to visit their web site, 114, in which case a separate browser window would launch to accomplish this.

While a receiver is listening to a track in this embodiment they can register their affirmation in two ways. First, there is provided a button to indicate that the receiver likes this particular track, 124 of FIG. 1. When the receiver clicks on this button a message is sent directly back through the electronic interface object as a vote of approval, and they get a message box alert of acknowledgment in return. Since this particular embodiment uses the internet for its communication capabilities this can be done as a page submission in the background without changing the display of the main interface itself. Were the electronic interface object to be implemented on a private electronic communication network there would be means provided to accomplish the same result by that route. In this case the software also alerts someone with a message box if they try to cast multiple votes for the same track, but any duplicates could also be tracked at the server end by the source numerical IP of the receiver. The integrity and fairness of a different voting feedback process has been a recent issue with the method used by American Idol, where some people brag that they vote hundreds of times, while others get busy signals trying to vote by phone and can't get through. But enabled by the hardware of the future disclosed here a person could vote directly back through the TV receiver on which they are viewing the show.

Second, there is a button to buy a copy of the track being played, 126 of FIG. 1. In the same way that comment tag information can be carried for other fields, the price of the item can be set dynamically in the pull down menu for the amount of the purchase, 122, as a new track starts to play. Though not specifically shown here the buy button could be for an outright contribution, with the pull down menu allowing the receiver to select an amount of their own choosing. Again the execution of the transaction can be handled as an internet page fetch in the background, without disturbing the playing of the audio or the basic display related to it. Because a person might make the decision to purchase or contribute after a track has just completed playing, we have provided in this embodiment the ability by radio buttons, 120, to go back and retrieve the descriptive information and related links for the previous track played. The buy button need not be just for a single track only, but in the case of a music artist could be for the electronic author's entire latest CD for a larger sum of money. An additional advantage of the custom software interface demonstrated here is that there need not be a function where the radio broadcast signal received through it can be saved for later playback, requiring the receiver to make a purchase to take possession for subsequent playback.

In this multiple channel implementation, the affirmations transmitted can provide feedback to determine which tracks should be featured in what might be designated the primary broadcast channel. As this interface is promoted and becomes popular, people can be expected to submit more and more of their own tracks, either through the incorporated submission link, 112 of FIG. 1, which opens up an upload web page in the receiver's default browser, or they can be otherwise led to the upload form on internet. It is anticipated that quickly there will be more tracks submitted than can be fit into a single broadcast schedule. What we can do with multiple channels therefore is to add additional channels as needed, and then provide all submitters with notifications of their scheduled broadcast times, along with an identification of the channel where their media creation will be played. With this information the truly motivated can give notice to their friends and supporters to download or otherwise access the electronic interface object, to be listening so as to cast their votes at those opportune times, and thereby boost their rankings in the system to graduate to the primary featured broadcast channel. At the same time we can choose to weight the value of each affirmation according to how many receivers there were for the media creation on that channel, so that we are actually measuring affirmations on a per capita basis for true response value. That is, an affirmation would be given more weight if generated by a media creation with fewer receivers.

This last example demonstrates a powerful new “farm club” model to propagate downloads and installations of the electronic media object itself, as well as generating excitement and participation in the system overall. In this manner people could upload their music creations on the hope of having it become a hit on the new system. There is even the likely possibility that once the system acquires a certain critical mass a feed could be provided to one of the satellite radio providers as one of their own channel choices, or syndicated in part to them or other existing broadcast outlets. For example, in the music realm there could be a “top hits” program of tracks on this new system provided as a freestanding radio show. All this can be expected to build even more submissions from those seeking exposure and stardom.

As another example of how the methods of this invention can enhance even a garden variety blog site, consider FIG. 2. Here we demonstrate how we can integrate affirmations functions by adding additional icons for this purpose to each such post. Blogs and other news postings already feature icons to print the post, 202 of FIG. 2, or email a link to the post to friends, 204. MSNBC.com has an icon to cast a vote of approval, 206, though not being used by them to affect the overall prominence of particular stories in their news site, and there is no indication that they might alter their publishing practices based on any direct visitor input. In the mockup demonstrated here we have also added an additional icon to accept contributions, 208. Standing alone, the invention of the business method of sharing contributions with blog posters is itself a novelty. Plain text links can serve the same function. And there is a listing in the blog page itself of direct links to the top posts, 210, as determined by the affirmations, so that they have meaningful prominence in the overall system. Incorporating this list into the menu functions of the page of every page would give maximum prominence, but we would at least expect to see such a listing on the main home page of the blog or other highest traffic areas.

These specific enhancements can be expected to yield an number of positive effects. Those who visit blogs so equipped will be made to feel that their opinion really matters and is being solicited to have a real impact. This increases the sense of engagement with those visitors. At the same time those who would consider posting to different blogs would be expected to preferentially post to those where there is some prospect of recognition of their work by affirmations of appreciation, or the further possibility of direct remuneration. This creates a new driving force to include links akin to the new functions disclosed here in the templates provided by the blog providers themselves, as those features are sought by blog creators.

To appreciate the advantage of the method of this invention over pre-existing methods, consider what would happen if a news site such as MSNBC.com were to actually make decisions about what stories to run based on visitor affirmations. There is an ongoing controversy in some circles about why some stories are completely ignored by the conventional corporate media while others are blown up entirely out of proportion. If there existed a media outlet which actually sought out, published, and meaningfully featured stories that people were individually responding to, one would expect that media outlet to greatly gain viewers at the expense of those not implementing these methods. No longer would some controlling editor be deciding what stories are more newsworthy than others. The people would have a voice on the filter between news events and themselves.

What we have demonstrated here is a direct system of visitor feedback, with the teaching that such feedback be given meaningful weight in the editorial process. There are more and more people who are not content only to be passive listeners or viewers. They want to be active participants in the media process. The methods taught herein can be implemented in other hardware configurations of the future, in full fledged video broadcasts, in media delivered to wireless devices like interactive cell phones and text communicators, and all manner of other electronic interfaces which may be developed by those skilled in the art. And in no case in any of the comparative examples of the past have we seen any which additionally provide for the income sharing models based on direct visitor action disclosed here.

### CONCLUSION

All the features disclosed in this specification (including any accompanying claims, abstract and drawings) may be replaced by alternative features serving the same, equivalent or similar purpose, unless expressly stated otherwise. It is expressly understood that each feature disclosed is one example only of a generic series of equivalent or similar features. Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims is not intended to invoke the provisions of 35 U.S.C. §112.

The methods and system of this invention represent a fundamental reorientation of the publishing process. Instead of just a one way transmission of content to a passive audience, we present here a vision of a fully interactive two way process, where not only can the audience give real feedback to the publisher as to the content they are receiving, but can even participate in the creation of that content, and furthermore directly benefit financially from their submissions. In this publishing world of the future, receiver input is not just an afterthought, but is taken as an integral part in the decision making process of what content to feature in the first place, not just a disconnected straw poll, but a way of directly influencing the source content itself. So it is that democracy can truly come to the media, in a world where the news itself, or the function of a program director, is driven by what people are actually responding to.

I respectfully claim:

1) A method of rewarding an electronic author, the method comprising:
(a) a plurality of electronic authors submitting media creations to an electronic publishing entity,
(b) the said electronic publishing entity making the said media creations available for perception through an electronic interface object to a plurality of receivers,
(c) the said receivers giving a plurality of affirmations of their appreciation of the media creations back through the same electronic interface object,
(d) arranging the overall prominence of the media creations within the electronic interface object according to the said affirmations.

2) The method of claim 1 wherein the said affirmations are in the form of votes of approval.

3) The method of claim 1 wherein the said affirmations are in the form of monetary contributions, and the rewarding is accounting with the said electronic authors as to a portion of the said contributions made associated with their media creations.

4) The method of claim 1 wherein the said affirmations are in the form of purchases of copies of the said media creations, and the rewarding is accounting with the said electronic authors as to a portion of the said purchases made of their media creations.

5) The method of claim 1, further comprising weighting the affirmations according to the number of receivers of the media creation.

6) The method of claim 1, further comprising the said electronic interface object providing a streaming media broadcast.

7) The method of claim 6 wherein the said prominence takes the form of times of broadcast of the media creations.

8) The method of claim 6 wherein the said prominence takes the form of inclusion of the media creations in a plurality of channels of the said electronic interface object with more receivers.

9) The method of claim 6, further comprising the said electronic interface object providing for accessing the information associated with a plurality of previous media creations played.

10) The method of claim 6, further comprising notifying the electronic authors of a plurality of the broadcast locations of their media creations, enabling them to promote it to potential receivers.

11) A system of rewarding an electronic author, the system comprising:
(a) an electronic publishing entity,
(b) means for a plurality of electronic authors to submit a media creations to the electronic publishing entity,
(c) an electronic interface object programmed by the electronic publishing entity using the said media creations submitted,
(d) means for making the electronic interface object accessible to a plurality of receivers so that the media creations are available for perception,
(e) means for the receivers of the media interface object to give a plurality of affirmations of their appreciation of the media creation back through the same electronic interface object.
(f) means for arranging the overall prominence of the media creations within the electronic interface object according to the said affirmations.

12) The system of claim 11, wherein the said affirmations are in the form of votes of approval.

13) The system of claim 11, wherein the said affirmations are in the form of monetary contributions, and the rewarding is accounting to the said electronic authors as to a portion of the said contributions made associated with their media creations.

14) The system of claim 11, wherein the said affirmations are in the form of purchases of a copies of the said media creations, and the rewarding is accounting with the said electronic authors as to a portion of the said purchases made of their media creations.

15) The system of claim 11, further comprising means for weighting the affirmations according to the number of receivers of the media creation.

16) The system of claim 11, further comprising means for the said electronic interface object to carry a streaming media broadcast.

17) The system of claim 16 wherein the said prominence takes the form of times of broadcast of the media creations.

18) The system of claim 16 wherein the said prominence takes the form of inclusion of the media creations in a plurality of channels of the said electronic interface object with more receivers.

19) The system of claim 16, further comprising means for accessing through the media interface object the information associated with a plurality of previous media creations played.

20) The system of claim 16, further comprising means for notifying the electronic authors of a plurality of the broadcast locations of their media creation, enabling them to promote it to potential receivers.

21) A method of rewarding an electronic author, the method comprising:
(a) a plurality of electronic authors submitting media creations to an electronic publishing entity,
(b) the said electronic publishing entity making the said media creations available for perception through an electronic interface object to a plurality of receivers,
(c) the said receivers making a plurality of contributions back through the same electronic interface object,
(d) accounting with the said electronic authors as to a portion of the said contributions made associated with their media creations.

22) A system of rewarding an electronic author, the system comprising:
(a) an electronic publishing entity,
(b) means for a plurality of electronic authors to submit a media creations to the electronic publishing entity,
(c) an electronic interface object programmed by the electronic publishing entity using the said media creations submitted,
(d) means for making the electronic interface object accessible to a plurality of receivers so that the media creations are available for perception,
(e) means for the said receivers to make a plurality of contributions back through the same electronic interface object,
(f) means for accounting with the said electronic authors as to a portion of the said contributions made associated with their media creations.
